(19) United States
(12) Patent Application Publication
(10) Pub. No.: US 2019/0325374 A1
(43) Pub. Date: Oct. 24, 2019

(54) SYSTEM AND METHOD FOR DRIVER SELECTION

(71) Applicant: GRABTAXI HOLDINGS PTE. LTD., Singapore (SG)

(72) Inventors: Yaozhang PAN, Singapore (SG); Swara DESAI, Singapore (SG); Cao YANG, Singapore (SG); Kong-Wei LYE, Singapore (SG); Kevin LEE, Singapore (SG)

(73) Assignee: Grabtaxi Holdings Pte. Ltd., Singapore (SG)

(21) Appl. No.: 16/068,005

(22) PCT Filed: Jan. 3, 2017
(86) PCT No.: PCT/SG2017/050002

§ 371 Date: Jul. 3, 2018

(30) Foreign Application Priority Data
Jan. 4, 2016 (SG) 10201600024T

(51) Int. Cl. G06Q 10/06; G06Q 50/30; G06Q 10/02

(52) U.S. Cl. CPC G06Q 10/063112; G06Q 10/06398; G06Q 10/02; G06Q 50/30; G06Q 10/063114

(57) ABSTRACT

A method for multiple-round driver selection performed by a computing system, the method including receiving a service request from a user device; identifying a plurality of driver candidates based in part on the service request, such that each of the plurality of driver candidates has driver data; for each of the plurality of driver candidates, generating a score based on the driver data; grouping the plurality of driver candidates into a plurality of candidate groups based in part on the score of each of the plurality of driver candidates; iteratively transmitting a job request to each candidate group of the plurality of candidate groups until one or more job acceptance is received in response to the job request, such that the job request is transmitted to all drivers in each candidate group; selecting one of the one or more job acceptances; and assigning the service request to the driver associated with the selected one of the one or more job acceptances.

### TECHNICAL FIELD

The present invention relates to a system and method for multiple-round selection in on-demand services. For example, the present invention relates to a method for multiple-round driver selection performed by a computing system.

### BACKGROUND

On-demand services exist to arrange transport services for a user to be provided by a driver. In providing on-demand transportation services, for example, it can be difficult to match passengers with an available taxi. At times, there may be multiple available taxis and only one passenger requesting a taxi, and many of the available taxi drivers will not receive the job. When a passenger makes a booking request for a taxi, the booking request is typically broadcast to many drivers as a job request. The drivers are expected to either accept, decline or ignore the job request. The drivers would then have to “bid” for the booking (i.e. accept the job request) if they wish to take up the booking, but only one of the many bidding drivers will actually be assigned the job. Therefore, the chance of success of getting the job may be relatively low. Drivers that fail to get jobs may grow frustrated and stop participating in the on-demand service. Therefore, there remains a need to address these and other problems in existing on-demand services.

### SUMMARY

According to various embodiments, the present invention provides a method for multiple-round driver selection performed by a computing system, the method including: receiving a service request from a user device; identifying a plurality of driver candidates based in part on the service request, wherein each of the plurality of driver candidates has driver data; for each of the plurality of driver candidates, generating a score based on the driver data; grouping the plurality of driver candidates into a plurality of candidate groups based in part on the score of each of the plurality of driver candidates; iteratively transmitting a job request to each candidate group of the plurality of candidate groups until one or more job acceptance is received in response to the job request, wherein the job request is transmitted to all drivers in each candidate group; selecting one of the one or more job acceptances; and assigning the service request to the driver associated with the selected one of the one or more job acceptances. The multiple-round driver selection method operates so that job requests get sent to fewer drivers but in a more targeted way, thereby reducing competition among the drivers and increasing the probability that a driver is selected for a job request, also referred to as the win rate. In this way, the method improves the driver selection process and win rate of each driver.

According to various embodiments, the step of identifying the plurality of driver candidates may include: receiving driver activity data in real time for each of a plurality of drivers; monitoring the activity data for each of the plurality of drivers; and determining which of the plurality of drivers are available to accept a job request, wherein the plurality of driver candidates is a subset of the plurality of drivers. By selecting the plurality of driver candidates from the plurality of drivers based on the real time driver activity data, the system is able to target drivers who are most likely to accept the job request, so as to improve the probability of driver candidates accepting the job request.

According to various embodiments, the step of grouping the plurality of driver candidates into a plurality of candidate groups may include: determining a ranking of the plurality of driver candidates based in part on the score of each of the plurality of drivers; determining a number of candidate groups; assigning each of the plurality of driver candidates to one of the plurality of groups based on the ranking. By ranking and grouping the plurality of driver candidates, the job request can be sent to driver candidates who are more likely to accept the job request, thereby improving the job request selection rate.

According to various embodiments, the service request includes user location data identifying the geographic position of the user device, and the driver data includes driver location data identifying the geographic position of the driver, and wherein the method further comprises: generating a proximity score based on the user location data and the driver location data, wherein the score is generated based in part on the proximity score. By generating the proximity score, the system would be able to take into consideration the proximity between the driver candidates and the user when generating the driver score.

According to various embodiments, the method may further comprise: generating a starvation score based on the driver data, the starvation score based in part on a number of unsuccessful acceptances by a driver over a predetermined period of time, wherein the driver score is generated based in part on the starvation score. By generating the starvation score, the system would be able to identify drivers who have not been selected after accepting the job requests.

According to various embodiments, the step of determining a ranking of the plurality of driver candidates may include adding a starvation weight to one or more of the plurality of driver candidate, wherein the starvation weight is based in part of the starvation score, and the starvation weight increases the ranking of the one or more plurality of driver candidates. By including the starvation weight in the ranking of the plurality of drivers candidates, the system would be able to rank driver candidates who have higher starvation scores higher in the rank of plurality of driver candidates so that the “starving” driver candidates have a better chance of being assigned the job request. In this way, the system would be able to include some lower ranked drivers in early selection rounds so that they sometimes get a higher priority of being selected.

According to various embodiments, the job request may be iteratively transmitted to each candidate group of the plurality of candidate groups one candidate group at a time.

According to various embodiments, the step of transmitting a job request to each candidate group of the plurality of candidate groups may include waiting a predetermined amount of time before transmitting the job request to a subsequent candidate group.

According to various embodiments, the step of iteratively transmitting the job request may include transmitting the job request to a first candidate group with the highest ranked plurality of driver candidates, wherein the sum of the scores of the highest ranked plurality of driver candidates is larger than or equal to the group score. By transmitting the job request to the group with the highest ranked plurality of driver candidates first, the system allows the job request a higher probability of being selected, thereby increasing the win rate.

According to various embodiments, the method may further include determining a group score for each of the plurality of candidate groups, wherein the group score comprises a sum of the scores of a plurality of driver candidates within a candidate group. By determining a group score for each of the plurality of candidate groups, the system would be able to determine the number of driver candidates in each of the plurality of candidate groups.

According to various embodiments, the step of determining the group score may include summing the scores of the plurality of driver candidates to obtain a total score, determining a number of candidate groups and dividing the total score by the number of candidate groups to obtain the group score.

According to various embodiments, the step of assigning the service request may include assigning the service request to the driver candidate having the highest starvation score.

According to various embodiments, the present invention provides a computing system for implementing a method of multiple-round driver selection, the computing system comprising: one or more processors; one or more memory resources in communication with the one or more processors, the one or more memory resources storing instructions that, when executed by the one or more processors, cause the computing system to: receive a service request from a user device; identify a plurality of driver candidates based in part on the service request, wherein each of the plurality of driver candidates has driver data; for each of the plurality of driver candidates, generate a score based on the driver data; group the plurality of driver candidates into a plurality of candidate groups based in part on the score of each of the plurality of driver candidates; iteratively transmit a job request to each candidate group of the plurality of candidate groups until one or more job acceptance is received in response to the job request, wherein the job request is transmitted to all drivers in each candidate group; select one of the one or more job acceptances; and assign the service request to the driver associated with the selected one of the one or more job acceptances.

According to various embodiments, the instructions may cause the computing system to identify the plurality of driver candidates by receiving driver activity data in real time for each of a plurality of drivers; monitor the activity data for each of the plurality of drivers; and determine which of the plurality of drivers are available to accept the job request, wherein the plurality of driver candidates is a subset of the plurality of drivers.

According to various embodiments, the instructions may cause the computing system to group the plurality of driver candidates into a plurality of candidate groups by determining a ranking of the plurality of driver candidates based in part on the score of each of the plurality of drivers; determining a number of candidate groups; and assigning each of the plurality of driver candidates to one of the plurality of groups based on the ranking.

According to various embodiments, the service request includes user location data identifying the geographic position of the user device, and the driver data includes driver location data identifying the geographic position of the driver, and wherein the instructions cause the computing system to generate a proximity score based on the user location data and the driver location data, wherein the score is generated based in part on the proximity score.

According to various embodiments, the instructions may cause the computing system to generate a starvation score based on the driver data, the starvation score based in part on a number of unsuccessful acceptances by a driver over a predetermined period of time, wherein the score is generated based in part on the starvation score.

According to various embodiments, the instructions may cause the computing system to determine a ranking of the plurality of driver candidates by adding a starvation weight to one or more of the plurality of driver candidate, wherein the starvation weight is based in part of the starvation score, and the starvation weight increases the ranking of the one or more plurality of driver candidates.

According to various embodiments, the job request may be iteratively transmitted to each candidate group of the plurality of candidate groups one candidate group at a time.

According to various embodiments, the instructions may cause the computing system to iteratively transmit a job request to each candidate group of the plurality of candidate groups by waiting a predetermined amount of time before transmitting the job request to a subsequent candidate group.

According to various embodiments, the instructions may cause the computing system to iteratively transmit the job request by transmitting the job request to a first candidate group with the highest ranked plurality of driver candidates, wherein the sum of the scores of the highest ranked plurality of driver candidates is larger than or equal to the group score.

According to various embodiments, the instructions may cause the computing system to determine a group score for each of the plurality of candidate groups, wherein the group score comprises a sum of the scores of a plurality of driver candidates within a candidate group.

According to various embodiments, the instructions may cause the computing system to determine the group score by summing the scores of the plurality of driver candidates to obtain a total score, determining a number of candidate groups and dividing the total score by the number of candidate groups to obtain the group score.

According to various embodiments, the instructions may cause the computing system to assign the service request by assigning the service request to the driver candidate having the highest starvation score.

### BRIEF DESCRIPTION OF THE DRAWINGS

FIG. 1 shows an example system for multiple-round driver selection.

FIG. 1A shows an example user device.

FIG. 1B shows an example driver device.

FIG. 2 shows a flow diagram of an example embodiment of a method for multiple-round driver selection.

FIG. 3 shows a flow diagram of an example embodiment of an iterative sub-process for multiple-round driver selection.

FIG. 4 shows an example score generating sub-system.

FIG. 5 shows a flow diagram of an example embodiment of a method for generating a score.

FIG. 6 is an illustration of an example prediction model of the multiple-round selection method.

### DETAILED DESCRIPTION

Embodiments of the present invention provide a multiple-round system and method for selecting service providers. Generally, an on-demand services system is used by both service requesters and services providers. In the described embodiments of the invention, the on-demand service being provided is transportation services, the service requester is a potential passenger in need of transportation services, such as a ride from his or her present location to an end destination, and the service providers are drivers, such as taxi drivers or independent contractor drivers, that are in need of passengers. However, embodiments of the present invention are not limited only to transportation services and may be used for other on-demand services.

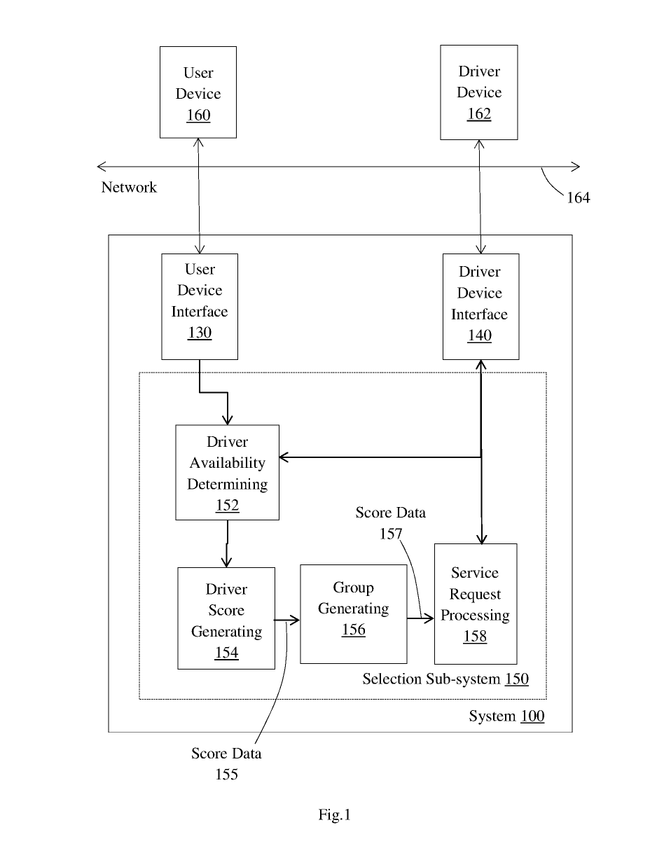

FIG. 1 shows an example system 100 for multiple-round driver selection. System 100 includes a user device interface 130, a driver device interface 140, a driver selection sub-system 150, a driver availability determining component 152, a score generating component 154, a group generating component 156, and a service request processing component 158. System 100 can communicate with a user device 160 and a driver device 162 over a network 164. The user device 160 is used by a user, who may be a passenger, for example, and the driver device 162 is used by a driver of a vehicle, for example, or another provider of on-demand services. The user device interface 130 manages communications between the system 100 and the user device 160. The driver device interface 140 manages communications between the system 100 and the driver device 162. The driver selection sub-system 150 selects a plurality driver candidates in response to a request from the user device 160. Driver selection sub-system 150 may include a driver availability determining component 152, a driver score generating component 154, a group generating component 156, and a service request processing component 158. System 100 may be implemented to broadcast the job request to the plurality of driver candidates.

One or more of the components and sub-systems of the system 100 can be implemented on network side resources, such as one or more servers having one or more processors and in communication with one or more memory resources. The system 100 can also be implemented through other computing systems in any other suitable alternative, or complementary, architectures, such as peer-to-peer networks. As an addition or alternative to these implementations, some or all of the components and sub-systems of the system 100 can be implemented on client devices, such as through applications that operate on the user device 160 and/or the driver device 162. The system can communicate over the network 164 by way of a network interface, such as wireless or wired network devices and protocols, to communicate with one or more user devices 160 and one or more driver devices 162. According to one implementation, the user device 160 and the driver device 162 each includes one or more processors and operates an application that can manage communications between the respective device and the user device interface 130 and the driver device interface 140, respectively. The system can also communicate with one or more non-volatile memory resources, where data and application software may reside and operate and also be accessible to the system. In example illustrations of the system 100, and components and sub-systems, some transmissions of data or information between the various devices, components, and sub-systems are shown. However, all devices, components, and sub-systems of the system 100 can have access to all data that is accessible to and received by the system 100. as necessary to implement embodiments of the disclosed method and system.

System 100 may receive a service request from the user device 160. System 100 may receive driver data in real time for each of a plurality of drivers. Upon receiving the driver data, the system 100 may identify a plurality of driver candidates based on at least one of the service request and the driver data. The driver data may include driver activity data, which can include information and details about the driver that is associated with that driver activity data, including both information on the driver's past behavior and real-time information on the driver's current status, position, or activity, in real-time. Real-time information may be obtained from the driver device 162. In identifying the plurality of driver candidates, the system 100 may be implemented to monitor the activity data for each of the plurality of drivers and determine which of the plurality of drivers is available to accept a job request. The plurality of driver candidates may be a subset of the plurality of drivers. From the plurality of drivers, the system 100 may identify the plurality of driver candidates based on the service request. System 100 may also identify the plurality of driver candidates based on the driver activity data. System 1(X) may also identify the plurality of driver candidates based on a combination of the service request and the driver activity data.

Referring to the driver selection sub-system 150, the driver availability determining component 152 may receive driver data from the driver device 162. The driver availability determining component 152 may determine the availability of the drivers based on driver data. Once the driver candidates are identified, the driver score generating component 154 may generate the score for each of the plurality of driver candidates based on the driver data of each of the plurality of driver candidates. Based on the scores of the plurality of driver candidates, the group generating component 156 may subdivide the plurality of driver candidates into a plurality of candidate groups and assign each of the plurality of driver candidates to one of the plurality of candidate groups. Once the plurality of candidate groups have been generated and the plurality of driver candidates assigned to one of the plurality of candidate groups, the service request processing component 158 may transmit the job request to the drivers in one of the plurality of candidate groups, a first candidate group. If none of the drivers in the first candidate group accept the job request, the service request processing component 158 may transmit the job request to the drivers in the next candidate group, a second candidate group. Service request processing component 158 may continue to transmit the job request to the subsequent candidate groups until at least one of the driver candidates accepts the job request, or until the system has transmitted the job request to all of the available candidate groups. In this way, the system iteratively transmits the job request to each of the candidate groups, one candidate group at a time, waiting a predetermined amount of time before transmitting the job request to the subsequent candidate group. If one or more driver candidates in a candidate group accepts the job request, the system 100 would continue to process the service request. For example, if more than one driver candidate accepts the job request, the system 100 may apply a process to determine which of the accepting driver candidates will be assigned the service request. According to one embodiment, the service request processing component 158 would assign the service request to the one or more accepting driver candidates. The service processing component 158 may transmit the assignment to the driver device 162 of the selected driver candidate.

FIG. 1A shows a block diagram of an example user device 160. User device 160 includes a transmitter 163, a receiver 164, a processor 166, a positioning module 168 and a user interface 169. User device 160 may be any type of mobile computing device, such as a mobile phone, tablet, watch, Global Navigation Satellite System (GNSS) navigation device, or built-in vehicle navigation device.

FIG. 1B shows a block diagram of an example driver device 162. Driver device 162 includes a transmitter 172, a receiver 174, a processor 176, a positioning module 178 and a user interface 179. Driver device 162 may be any type of mobile computing device, such as a mobile phone, tablet, watch, Global Navigation Satellite System (GNSS) navigation device, or built-in vehicle navigation device. Figs. IA and 1B show only one example configuration of a suitable user device 160 and driver device 162, and other configurations may be used.

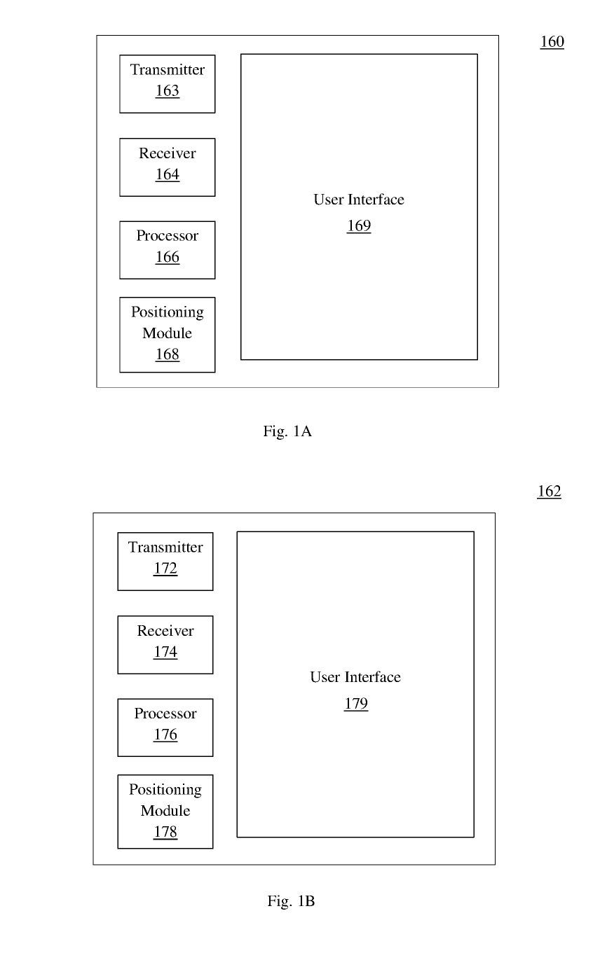

FIG. 2 shows a flow diagram of an example embodiment of a method for multiple-round driver selection. In step 202, the system 100 (FIG. 1) receives a service request from the user device 160. In response to receiving the service request, the system identifies a plurality of driver candidates based in part on the service request (204). The service request includes information about the user that is transmitting the service request, such as the user's geographic location, usage history, user rating, and any other desired information that is maintained by the system 100. Each of the plurality of driver candidates has its own driver data that is associated with that specific driver. For each of the plurality of driver candidates, the system 100 generates a score, or driver score, based on the driver data (206), and groups the plurality of driver candidates into a plurality of candidate groups based in part on the score of each of the plurality of driver candidates (208). In an iterative sub-process 210, the system 100 iteratively transmits a job request to each candidate group of the plurality of candidate groups until one or more job acceptance is received in response to the job request, the job request being transmitted to all drivers in each candidate group. The job request may also be transmitted to a subset of the drivers in each candidate group. In step 222, the system 100 assigns the service request to one of the driver candidates that accepts the job request, if at least one of the driver candidates accepts the job request. If none of the driver candidates accepts the job request, then the method 200 ends. In one embodiment, where multiple job acceptances are received, the system 100 selects one of the one or more job acceptances and assigns the service request to the driver associated with the selected one of the one or more job acceptances. The service request may include at least user information and a location of the user.

The step of grouping the plurality of driver candidates into the plurality of candidate groups based on the scores (208) may include the additional steps of: determining a ranking of the plurality of driver candidates based in part on the score of each of the plurality of driver candidates; determining a number of candidate groups; and assigning each of the plurality of driver candidates to one of the plurality of groups based on the ranking. The system 100 may rank the plurality of drivers before grouping the plurality of driver candidates into the plurality of candidate groups. The system 100 may rank the plurality of driver candidates according to a descending order where a driver with the highest score is at the top of the ranking and a driver with the lowest score is at the bottom of the ranking. Alternatively, the system 100 may rank the plurality of driver candidates according to any desired criteria. Upon ranking the plurality of driver candidates, the system 100 may group the plurality of driver candidates and iteratively transmit the job request to the plurality of candidate groups. Once a job request has been accepted by a driver candidate, the service request may be assigned to the driver. The service request may be the same as the job request, where the service request received by the system 100 is transmitted to the selected driver. The job request may also be a subset of information from the service request, and where the job request is assigned to the driver, the driver is authorized by the system to provide the service requested in the service request.

In one implementation, the system 100 determines a preferred group score based on the plurality of driver candidates. Each of the plurality of candidate groups may be formed such that each of the candidate groups has a group score, which is a sum of the scores of the plurality of driver candidates within a candidate group. Driver candidates may be grouped such that the group score of the candidate group is larger than or equal to the preferred group score. The system may determine the preferred group score by: determining a total score that is the sum of the scores of all of the drivers in the plurality of driver candidates; determining the number of candidate groups, and dividing the total score by the number of candidate groups. As mentioned, the number of candidate groups may be pre-determined. The preferred group score may be pre-determined. Multiple groups may be formed by selecting the driver candidates for each group until all the driver candidates have been selected for one of the candidate groups. The preferred group score may be generated based on a pre-determined number of groups.

Referring to FIG. 2, in an iterative sub-process 210, the system 100 iteratively transmits a job request to each candidate group of the plurality of candidate groups until one or more job acceptance is received in response to the job request. System 100 sends the job request to one of the plurality of candidate groups (211). In step 212, the system 100 determines if a job acceptance is received from any one of the drivers in the candidate group. If yes, then the system 100 assigns the service request to the driver that transmitted the job acceptance (222). At step 212, if no job acceptance is received by the system 100 from at least one drivers in the one of the plurality of candidate groups, the system 100 determines if there is another candidate group that has yet to receive the job request (214). If there is another candidate group that has yet to receive the job request, the system 100 sends the job request to the another candidate group (216). System 100 may iteratively send the job request to the all of the available candidate groups until a job acceptance is received from a driver, or until there are no remaining candidate groups. In the event that the system 100 sends the job request to all of the plurality of candidate groups and does not receive a job acceptance from a driver, the system 100 may inform the user that there are no drivers available to attend to the service request.

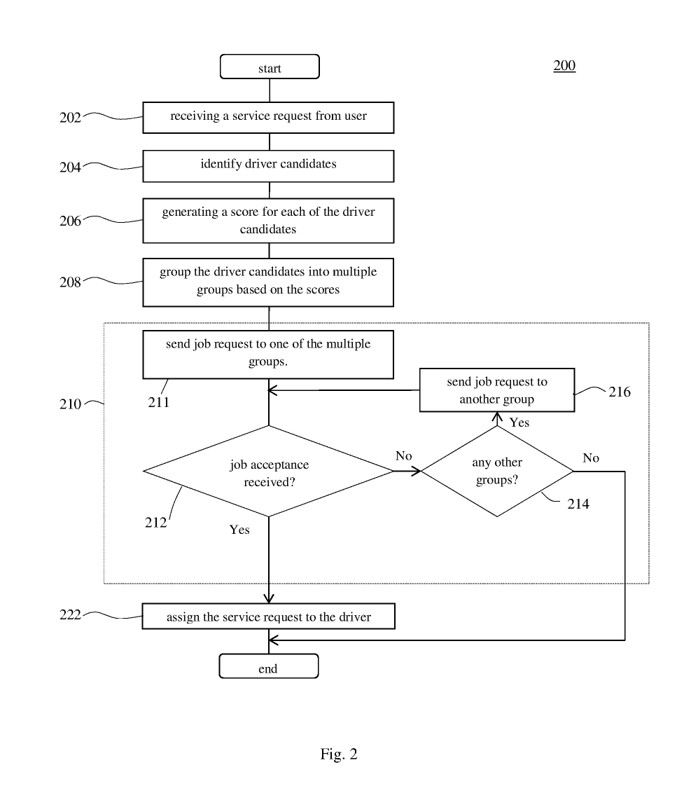

FIG. 3 shows an example embodiment of an iterative sub-process 310. The iterative sub-process 310 of FIG. 3 may be substituted for the iterative sub-process 210 shown in the method 200 illustrated in FIG. 2. In the iterative sub-process 310 of FIG. 3, the system 100 sends the job request to one of the plurality of candidate groups (311). In step 312, the system 100 determines if a job acceptance is received from any one of the drivers in the candidate group. If yes, the system 100 determines if more than one job acceptance has been received by the system 100 (318). If more than one job acceptance has been received, the system 100 may select one of the job acceptances(320), and assigning the service request to the driver candidate associated with the selected job acceptance (322). At step 312, if no job acceptance is received by the system 100 from at least one drivers in the one of the plurality of candidate groups, the system 100 determines if there is another candidate group that has yet to receive the job request (314). If there is another candidate group that has yet to receive the job request, the system 100 sends the job request to the another candidate group (316). System 100 may iteratively send the job request to the all of the available candidate groups until a job acceptance is received from a driver, or until there are no remaining candidate groups.

Driver data includes at least one of the following information: time since the last acceptance of a job request; time since the last decline of a job request; time since the last assignment of job to the driver; time difference between the drop off time of the previous passenger and the service request time; number of acceptances received from the driver over a pre-determined period of time; distance of the driver from the user transmitting the service request; and location of the driver. From the driver data, the system 100 can calculate the probability of a driver being able to accept the job request. In addition, the system 100 can predict whether a driver is likely to be available to accept the job request. For example, the driver may have a passenger in his vehicle at the time of receiving of the job request.

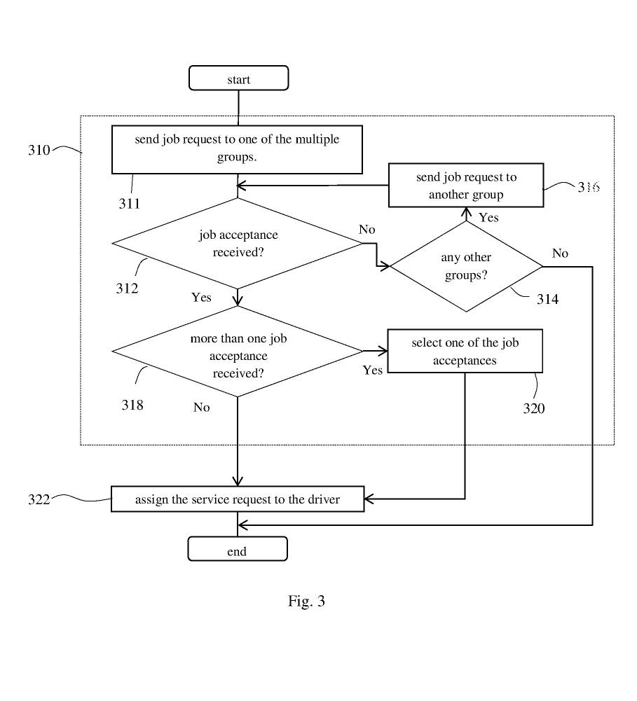

FIG. 4 shows an example driver score generating sub-system 400. The driver score generating sub-system 400 is one example embodiment of the driver score generating component 154 (FIG. 1). Driver score generating sub-system 400 includes an acceptance probability generating component 402, a distance score generating component 404 and a starvation score generating component 406. The driver score generating sub-system 400 receives driver data 408 and a service request 410 and generates a driver score 412 based on the driver data 408 and the service request 410. Driver score 412 may be transmitted to the group generating component 156 (FIG. 1) and used to generate the plurality of candidate groups.

Acceptance probability generating component 402 may generate an acceptance probability score 414 based on the driver data 408. Acceptance probability score 414 may be a measure of the probability that the driver would be able to accept the job request, based on the driver data 408. Acceptance probability generating component 402 may consider the recent behavior of the driver to determine if the driver is available for a new job. For example, if a driver is unresponsive to the job request, it is likely that the driver already has a passenger. This is possible if the driver uses multiple systems for finding jobs or if the driver is a taxi driver. In addition, the acceptance probability generating component 402 may consider the service requests, factoring in information such as pick-up location, drop-off location, and the driver's current location. Acceptance probability generating component 402 may consider the driver's profile, factoring in such information as whether the driver works for a particular company, the driver's typical working hours, as well as the driver's first and last known locations, which may be used to predict the first and last ride in the direction of his final destination. System 100 may predict if a driver is available or not. By predicting the probability that a driver will accept a job request, the system 100 may also predict whether the driver is available for a new job or already has another passenger in the vehicle.

Proximity score generating component 404 may generate a proximity score 418 based on the user data from the service request 410 and driver data 408. Proximity score 418 may be generated based on the distance between the driver candidate and the user. Service request 410 may include user location data identifying the geographic position of the user. Driver data 408 may include driver location data identifying the geographic position of the driver. Proximity score generating component 404 may also generate the proximity score 418 based on the user location data and the driver location data.

Starvation score generating component 406 may generate a starvation score 420 based on the driver data 408. Starvation score 420 may be based in part on a number of unsuccessful acceptances made by the driver over a pre-determined period of time. Drivers are considered to be “starved” when the system does not assign them service requests, even though they have accepted many job requests. A certain service request may not be assigned due to a low acceptance probability score 414 and/or a low proximity score 418 over a pre-determined period of time. The starvation score 420 of a driver would increase as the duration of time that the driver is not assigned a service request increases.

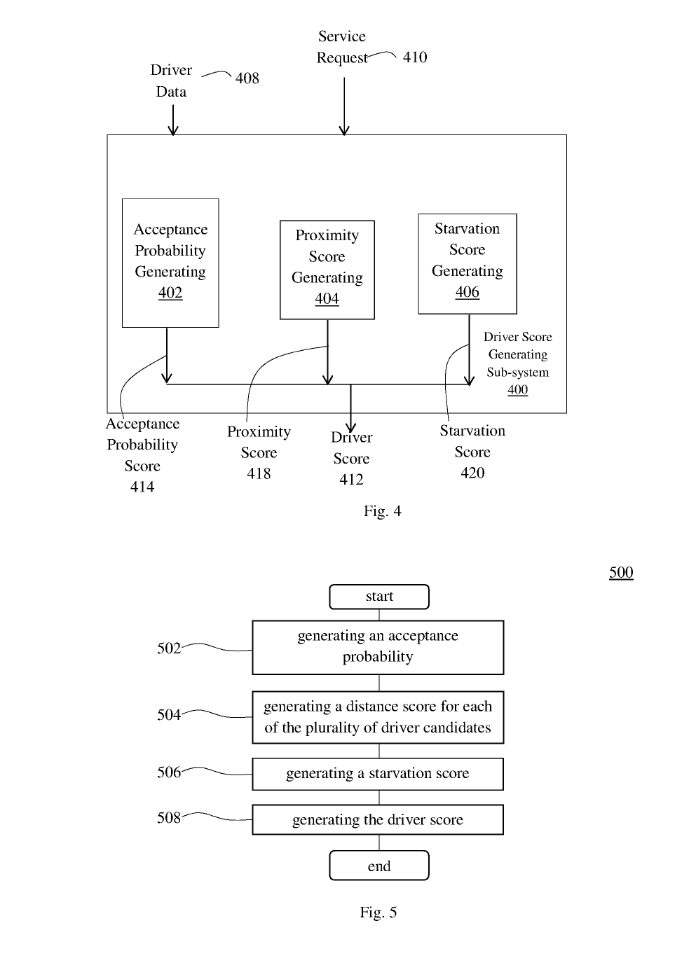

FIG. 5 shows a flow diagram for an example method 500 for generating the driver score 412 (FIG. 4). The method 500 may be performed by the system 100 (FIG. 1) and the driver score generating sub-system 400 (FIG. 4). In method 500, the system 100 generates an acceptance probability score based on the driver data 408 (502). System 100 generates a proximity score for each of the plurality of driver candidates based on the driver data 408 and service request 410 (504). The system 100 generates a starvation score based on the driver data 408 (506). System 100 generates the driver score 412 based on at least one of: the acceptance probability score; the proximity score; and the starvation score.

When determining a ranking of the plurality of driver candidates, the system 100 may add a starvation weight to one or more of the plurality of driver candidate. Starvation weight may be based in part of the starvation score. Starvation weight may increase the ranking of the one or more plurality of driver candidates.

System 100 may wait for a pre-determined amount of time for the driver candidates in a candidate group to accept the job request that has been transmitted to the candidate group. If no response is received from driver candidates in the candidate group after waiting the predetermined amount of time, the system 100 may transmit the job request to the subsequent candidate group.

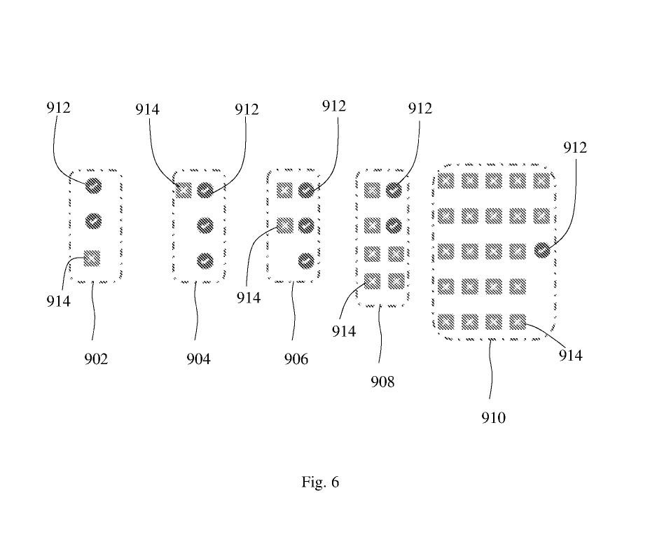

FIG. 6 is an illustration of an example prediction model of the multiple-round selection method. In the illustrated prediction model, a plurality of driver candidates are grouped into a first group 902, a second group 904, a third group 906, a fourth group 908, and a fifth group 910. The prediction model estimates that each group will include accepting drivers 912 that accept the job request and unresponsive drivers 914 that either reject the job request or do not respond to the job request. Accepting drivers 912 are indicated by a round “check” image, and unresponsive drivers 914 are indicated by a square “x” image. The illustration of FIG. 6 shows what example groups would look like, according to embodiments of the invention. In an example first group 902, the job request is sent to a total of three driver candidates, and there are two accepting drivers 912. One of the two accepting drivers will be assigned the job.

In the first group 902, the acceptance rate, or the rate of acceptance of the job request, is about 66.7% (2 out of 3), and the selection rate, or that chance of being selected for the job request (also referred to as the “win” rate), is 50% (1 out of 2). Since the job request is accepted by a driver candidate in the first group 902, the job request would not be sent to subsequent groups.

In the example second group 904, the job request is sent to a total of four driver candidates, and there are three accepting drivers 912. One of the three accepting drivers will be assigned the job. In the second group 904, the acceptance rate is about 75% (3 out of 4), and the selection rate is about 33% (1 out of 3). Since the job request is accepted by a driver candidate in the second the group 904, the job request would not be sent to subsequent groups. Similarly, for the third group 906, fourth group 908, and fifth group 910, the selection rate remains relatively high.

When the plurality of ranked driver candidates are grouped in a plurality of candidate groups, each of the candidate groups having about the same group score, the group size increases from the first candidate group 902 to the fifth candidate group 910. As driver candidates in the first candidate group 902 have the highest driver scores, the first candidate group 902 would have the fewest number of driver candidates. Similarly, as the scores of the driver candidates in the fifth candidate group 910 are the lowest, the fifth candidate group 910 would have the greatest number of driver candidates. As shown, the size of groups may keep increasing to make the group score of each candidate group approximately the same as the other candidate groups. In this way, there are fewer driver candidates in the candidate group if the driver candidates are high scoring driver and vice versa. System 100 may generate the group score by summing the scores of the plurality of driver candidates to obtain a total score for the group.

System 100 may include some lower ranked drivers in early groups in a manner so that the lower ranked drivers may have a higher probability of receiving the job request. In one implementation, the system 100 may add a starvation weight to the score of one or more of the plurality of driver candidates thereby increasing the ranking of the one or more plurality of driver candidates. In another implementation, the system 100 may transmit the job request to at least one driver candidate with the highest starvation score.

Driver data may be stored in the driver device 162 and transmitted wirelessly to the system 100. System 100 may include a driver database, which stores the data on each of the drivers using the system 100. System may also include a user database, which stores the data on each of the users using the system 100. The driver database and the user database may use the same memory resources that are in communication with the system 100. Part of the driver data may be stored in the driver database.

System 100 improves the “selection rate” of the driver candidates by providing the drivers with a more targeted job request. By sending the job request to a smaller group of driver candidates, and not to the other driver candidates who may potentially not accept the job request, the “win rate” of the driver candidate would increase.

Generally, the driver candidates only accept job requests that they want. When a job request is broadcasted to a large number of driver candidates, but only one of the driver candidates is selected for the job, a larger number of drivers would not be assigned the job.

As an alternative to the groupings illustrated in FIG. 6, a conventional selection process would have a job request sent to all forty-three driver candidates at once, and as many as eleven drivers may accept the job request. As such, the acceptance rate is about 26% (11 out of 43), and the selection rate is about 9% (1 out of 11). Therefore, the win rate of each driver candidate in a conventional process is low. This would lead to low driver satisfaction. Consequently, the drivers tend to accept a job request even if they may not be interested in or able to accept the job. The driver candidate may quickly accept a job request just to increase their chances of being selected. They may later cancel, or back out of the job, if they are unable to take the job or they just do not like the job because, for example, it has a short distance or an undesirable destination. This leads to many driver candidates accepting jobs requests indiscriminately instead of making a thoughtful decision to accept a job request. Such cancellation also affects users' experience severely as such driver cancellation results in increasing wait time for users.

One advantage provided by embodiments of the current system and method is maintaining the same, or approximately equal, group score for each of the plurality of candidate groups. By maintaining the same group score for each of the plurality of candidate groups, the group size of the plurality of candidate groups is increased. This would ensure that the overall probability of a driver selecting the job request in each group is approximately equal.

Another advantage provided by embodiments of the current system and method is ranking the plurality of driver candidates in descending order. When the plurality of driver candidates are ranked in a descending order, the plurality of driver candidates may be grouped in the same order such that the first candidate group of driver candidates would include drivers with the highest scores, the second candidate group of driver candidates would include drivers with the next highest scores, and the last candidate group of driver candidates would include drivers with the lowest scores.

Another advantage provided by embodiments of the current system and method is through ranking the plurality of driver candidates. Upon ranking the plurality of driver candidates, the system 100 (FIG. 1), when iteratively transmitting the job request, may transmit the job request to a first candidate group with the highest ranked plurality of driver candidates. The sum of the scores of the highest ranked plurality of driver candidates in the first group may be larger than or equal to the group score.

1. A method for multiple-round driver selection performed by a computing system, the method comprising:
receiving a service request from a user device;
identifying a plurality of driver candidates based in part on the service request, wherein each of the plurality of driver candidates has driver data;
for each of the plurality of driver candidates, generating a score based on the driver data;
grouping the plurality of driver candidates into a plurality of candidate groups based in part on the score of each of the plurality of driver candidates;
iteratively transmitting a job request to each candidate group of the plurality of candidate groups until one or more job acceptance is received in response to the job request, wherein the job request is transmitted to all drivers in each candidate group;
selecting one of the one or more job acceptances; and
assigning the service request to the driver associated with the selected one of the one or more job acceptances.

2. The method of claim 1, wherein identifying the plurality of driver candidates includes: receiving driver activity data in real time for each of a plurality of drivers; monitoring the activity data for each of the plurality of drivers; and determining which of the plurality of drivers are available to accept the job request, wherein the plurality of driver candidates is a subset of the plurality of drivers.

3. The method of claim 1 or 2, wherein grouping the plurality of driver candidates into a plurality of candidate groups includes: determining a ranking of the plurality of driver candidates based in part on the score of each of the plurality of drivers; determining a number of candidate groups; and assigning each of the plurality of driver candidates to one of the plurality of groups based on the ranking.

4. The method of any one of claims 1 to 3, wherein the service request includes user location data identifying the geographic position of the user device, and the driver data includes driver location data identifying the geographic position of the driver, and wherein the method further comprises: generating a proximity score based on the user location data and the driver location data, wherein the score is generated based in part on the proximity score.

5. The method of any one of claims 1 to 4, further comprising: generating a starvation score based on the driver data, the starvation score based in part on a number of unsuccessful acceptances by a driver over a predetermined period of time, wherein the score is generated based in part on the starvation score.

6. The method of claim 5, wherein determining a ranking of the plurality of driver candidates includes adding a starvation weight to one or more of the plurality of driver candidate, wherein the starvation weight is based in part of the starvation score, and the starvation weight increases the ranking of the one or more plurality of driver candidates.

7. The method of any one of claims I to 6, wherein the job request is iteratively transmitted to each candidate group of the plurality of candidate groups one candidate group at a time.

8. The method of claim 7, wherein iteratively transmitting a job request to each candidate group of the plurality of candidate groups includes waiting a predetermined amount of time before transmitting the job request to a subsequent candidate group.

9. The method of any one of claims 1 to 8, wherein iteratively transmitting the job request includes transmitting the job request to a first candidate group with the highest ranked plurality of driver candidates, wherein the sum of the scores of the highest ranked plurality of driver candidates is larger than or equal to the group score.

10. The method of any one of claims 1 to 9, further comprising determining a group score for each of the plurality of candidate groups, wherein the group score comprises a sum of the scores of a plurality of driver candidates within a candidate group.

11. The method of claim 10, wherein determining the group score includes summing the scores of the plurality of driver candidates to obtain a total score, determining a number of candidate groups, and dividing the total score by the number of candidate groups to obtain the group score.

12. The method of any one of claims 6 to 11, wherein assigning the service request includes assigning the service request to the driver candidate having the highest starvation score.

13. A computing system for implementing a method of multiple-round driver selection, the computing system comprising:
one or more processors;
one or more memory resources in communication with the one or more processors, the one or more memory resources storing instructions that, when executed by the one or more processors, cause the computing system to:
receive a service request from a user device;
identify a plurality of driver candidates based in part on the service request, wherein each of the plurality of driver candidates has driver data;
for each of the plurality of driver candidates, generate a score based on the driver data;
group the plurality of driver candidates into a plurality of candidate groups based in part on the score of each of the plurality of driver candidates;
iteratively transmit a job request to each candidate group of the plurality of candidate groups until one or more job acceptance is received in response to the job request, wherein the job request is transmitted to all drivers in each candidate group;
select one of the one or more job acceptances; and
assign the service request to the driver associated with the selected one of the one or more job acceptances.

14. The computing system of claim 13, wherein the instructions cause the computing system to identify the plurality of driver candidates by receiving driver activity data in real time for each of a plurality of drivers; monitor the activity data for each of the plurality of drivers; and determine which of the plurality of drivers are available to accept the job request, wherein the plurality of driver candidates is a subset of the plurality of drivers.

15. The computing system of claim 13 or 14, wherein the instructions cause the computing system to group the plurality of driver candidates into a plurality of candidate groups by determining a ranking of the plurality of driver candidates based in part on the score of each of the plurality of drivers; determining a number of candidate groups; and assigning each of the plurality of driver candidates to one of the plurality of groups based on the ranking.

16. The computing system of any one of claims 13 to 15, wherein the service request includes user location data identifying the geographic position of the user device, and the driver data includes driver location data identifying the geographic position of the driver, and wherein the instructions cause the computing system to generate a proximity score based on the user location data and the driver location data, wherein the score is generated based in part on the proximity score.

17. The computing system of any one of claims 13 to 16, wherein the instructions cause the computing system to generate a starvation score based on the driver data, the starvation score based in part on a number of unsuccessful acceptances by a driver over a predetermined period of time, wherein the score is generated based in part on the starvation score.

18. The computing system of claim 17, wherein the instructions cause the computing system to determine a ranking of the plurality of driver candidates by adding a starvation weight to one or more of the plurality of driver candidate, wherein the starvation weight is based in part of the starvation score, and the starvation weight increases the ranking of the one or more plurality of driver candidates.

19. The computing system of any one of claims 13 to 18, wherein the job request is iteratively transmitted to each candidate group of the plurality of candidate groups one candidate group at a time.

20. The computing system of claim 19, wherein the instructions cause the computing system to iteratively transmit a job request to each candidate group of the plurality of candidate groups by waiting a predetermined amount of time before transmitting the job request to a subsequent candidate group.

21. The computing system of any one of claims 13 to 20, wherein the instructions cause the computing system to iteratively transmit the job request by transmitting the job request to a first candidate group with the highest ranked plurality of driver candidates, wherein the sum of the scores of the highest ranked plurality of driver candidates is larger than or equal to the group score.

22. The computing system of any one of claims 13 to 21, wherein the instructions cause the computing system to determine a group score for each of the plurality of candidate groups, wherein the group score comprises a sum of the scores of a plurality of driver candidates within a candidate group.

23. The computing system of claim 19, wherein the instructions cause the computing system to determine the group score by summing the scores of the plurality of driver candidates to obtain a total score, determining a number of candidate groups, and dividing the total score by the number of candidate groups to obtain the group score.

24. The computing system of any one of claims 18 to 23, wherein the instructions cause the computing system to assign the service request by assigning the service request to the driver candidate having the highest starvation score.
